(19) United States
(12) Patent Application Publication
(10) Pub. No.: US 2007/0147095 A1
(43) Pub. Date: Jun. 28, 2007

(54) LIGHT REFLECTOR SOCKET DEVICE

(76) Inventor: Rajiam Pursifull, Portland, OR (US)

Correspondence Address: KLARQUIST SPARKMAN, LLP, 121 SW SALMON STREET, SUITE 1600, PORTLAND, OR, 97204, US

(21) Appl. No.: 11/562,937

(22) Filed: Nov. 22, 2006

Related U.S. Application Data
(60) Provisional application No. 60/738,554, filed on Nov. 22, 2005.

(51) Int. Cl. H01R 33/00

(52) U.S. Cl. 362/640

(57) ABSTRACT

Disclosed is a light reflector socket device comprising a socket having a socket housing and a socket wire, a junction box having a junction box body with multiple junction box guide track slots, each of which is defined by a set of junction box guide tracks, and a reflector adaptor having multiple adaptor plate adjustment brackets that can be secured to corresponding junction box guide tracks.

### CROSS-REFERENCE TO RELATED APPLICATION

This claims the benefit of U.S. Provisional Application No. 60/738,554, filed Nov. 22, 2005, the disclosure of which is hereby incorporated herein by reference.

### TECHNICAL FIELD

The present invention relates generally to adjustable light socket devices.

### BACKGROUND

Light sockets have been used in conjunction with light reflectors for many years. Such combinations have been used, for example, by gardeners and commercial greenhouses for use in growing plants indoors. In those situations, light plays a key role in the growth of the plants. The intensity and quality of the light provided are of great concern. To optimize the quantity and quality of light, indoor plant growers usually use reflectors to direct light from light sources. The mere presence of a reflector, however, is not enough. A light source must be properly positioned relative to a reflector to provide an optimal amount of light depending on the situation, which may change.

While several adjustable light sockets, such as the one described in U.S. Pat. No. 7,025,479, are known, each has been inefficient in some regard. For example, some adjustable sockets, such as the one disclosed in U.S. Pat. No. 7,025,479, have several holes drilled into the side of a mounting member. A corresponding reflector mounting plate has several holes drilled into mounting flanges connected to the mounting plate. The mounting plate can be attached to the mounting member by inserting screws through the holes in the mounting flanges and then into the holes in the mounting member. This arrangement is limiting because there is a small, fixed number of positions in which the mounting plate may be attached to the mounting member. Also, it can be difficult and time-consuming to reposition the mounting plate once it is attached to the mounting member because all of the mounting screws need to be completely removed before the mounting flanges can be placed in a different location, at which point all of the screws need to be aligned with the new corresponding holes and screwed into place. In addition, many individual holes need to be created in both the mounting member and the mounting flanges connected to the mounting plate.

Thus, there exists a need for an adjustable light reflector socket device that is easy to manufacture and provides significant ease of use and flexibility in the positioning of a light source relative to a reflector.

### SUMMARY

A light reflector socket device can include a socket having a socket housing, at least one electrical conductor for supplying electricity to the socket, a junction box (j-box) body having several j-box guide track slots, each of which can be defined by a set of j-box guide tracks, and a reflector adaptor having several adjustment brackets. In some embodiments, the adjustment brackets are separate components securely attached to the reflector adaptor. In alternative embodiments, the reflector adaptor and the corresponding adjustment brackets are of unitary construction. The adaptor plate may be secured to a light reflector to support the socket at an appropriate position.

In some embodiments, the adaptor plate adjustment brackets are adapted to be placed along a corresponding set of j-box guide tracks. An adaptor plate adjustment bracket mounting assembly can be used to securely attach each adaptor plate adjustment bracket to the corresponding set of j-box guide tracks using, for example, a guide track bolt in conjunction with a guide track nut that can be inserted into a corresponding j-box guide track channel defined by a corresponding j-box guide track.

In some embodiments, the adaptor plate adjustment brackets can be easily repositioned along the corresponding j-box guide tracks with the corresponding adaptor plate adjustment bracket mounting assemblies in place. By loosening, but not necessarily removing or substantially removing, each guide track bolt from a corresponding guide track nut, the reflector adaptor can be readily moved to a different position with respect to the j-box body. Once the reflector adaptor is in the desired new location, the guide track bolts can be re-tightened into the corresponding guide track nuts.

In some embodiments, the j-box body can be formed with built-in heat sink components that can provide heat sink functionality. This is desirable because of the potentially significant amount of heat generated by light bulbs that should, or often needs, to be dissipated at least in part.

### BRIEF DESCRIPTION OF THE DRAWINGS

In the drawings:

FIG. 1 is an exploded oblique view of a light reflector socket device that includes a socket, a socket junction box (j-box) body, and a j-box reflector adaptor plate.

FIG. 2 is an enlarged exploded oblique view of a portion of the light reflector socket device of FIG. 1.

FIG. 3 is an oblique view of the socket and j-box reflector adaptor plate of the light reflector socket device of FIG. 1.

FIG. 4 is an oblique view of the light reflector socket device of FIG. 1 with the j-box reflector adaptor plate in a first position with respect to the socket j-box body.

FIG. 5 is an oblique view of the light reflector socket device of FIG. 1 with the j-box reflector adaptor plate in a second position with respect to the socket j-box body.

FIG. 6 is an oblique view of the light reflector socket device of FIG. 1 with the j-box reflector adaptor plate in a third position with respect to the socket j-box body.

FIGS. 7A-B are side views of the light reflector socket device of FIG. 1 with the j-box reflector adaptor plate in an example position with respect to the socket j-box body.

FIGS. 7C-D are side views corresponding to FIGS. 7A-B, respectively, showing only the j-box reflector adaptor plate and mounting assemblies.

FIG. 8A is a vertical cross-sectional view of the light reflector socket device taken along line 8A-8A of FIG. 1.

FIG. 8B is a vertical cross-sectional view of the light reflector socket device taken along line 8B-8B of FIG. 1.

FIG. 9 is a side view of the light reflector socket device taken along line 9-9 of FIG. 1.

FIG. 10 is a vertical cross-sectional view of the light reflector socket device taken along line 10-10 of FIG. 1.

FIG. 11 is an oblique view of an alternative embodiment of a light reflector socket assembly that includes a j-box body, three reflector adaptor adjustment brackets, and a reflector adaptor.

FIG. 12A is an oblique views of a light reflector assembly that includes a light reflector mounted to a light reflector socket device using adaptor plate adjustment brackets and a reflector adaptor plate.

FIG. 12B is a side view of the light reflector assembly of FIG. 12A.

FIG. 12C is a bottom view of the light reflector assembly of FIG. 12A.

### DETAILED DESCRIPTION

In the following description of the disclosed technology, reference is made to the accompanying drawings which form a part hereof, and in which are shown by way of illustration specific embodiments in which the invention may be practiced. Other embodiments may be utilized and structural changes may be made without departing from the scope of the disclosed technology.

FIG. 1 shows a light reflector socket device 100 for use with a reflector. The device has a socket 1 and a socket junction box (j-box) body 18. In the example, the socket 1 is a 5 kV position-oriented socket. The socket j-box body 18 has a sidewall that is generally cylindrical. A socket insulator 4 and a j-box inner end plate 7 are located between the socket 1 and the j-box 18 and held fixed in place by two screws 3 that pass through two socket screw holes 6A through the socket insulator 4 and two socket screw holes 6B through the j-box inner end plate 7. Two electrical wires extend from the socket 1 and pass through holes 5A and 5B defined by the socket insulator 4 and the j-box inner end plate 7, respectively.

In the example, a j-box reflector adaptor plate 8 defines multiple connection holes 10 through which thumb screws 14 may be passed to be secured in wing nuts 13. Some or all of the connection holes 10 are positioned to mate with facing holes in a light reflector so the reflector can be coupled with the j-box reflector adaptor plate 8 by use of the thumb screws 14 and the wing nuts 13. Additional holes 10a are provided in the j-box reflector adaptor plate 8 that can be used in conjunction with coupling the reflector to the j-box reflector adaptor plate 8 or for other purposes.

In the example four thumb screws 14 are used, each being ½-inch size 8 screws having 32 threads per inch and four wing nuts 13 are used, each being size 8 having 32 threads per inch.

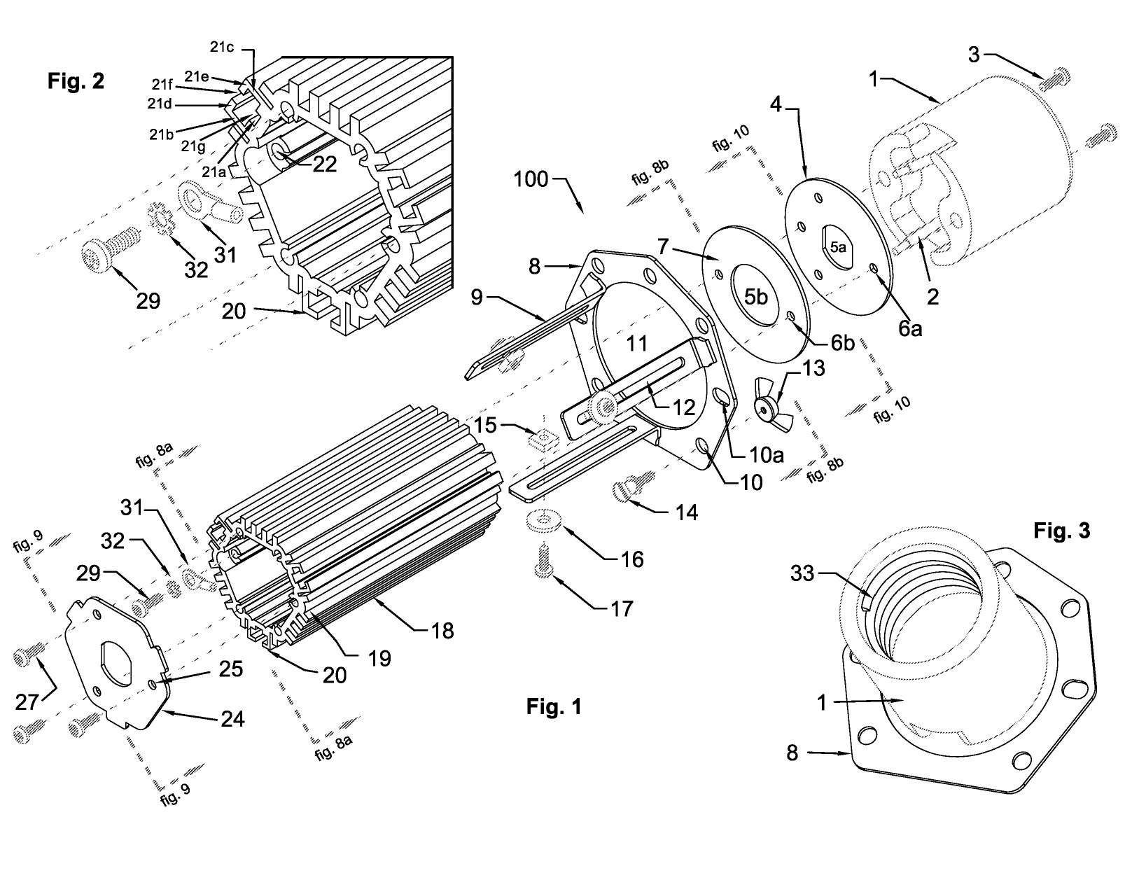

In the example, three adaptor plate adjustment brackets 9 extend axially from the j-box reflector adaptor plate 8. Each adaptor plate adjustment bracket 9 has an adjustment bracket slot 12. Each j-box guide track 20 has a channel 21g defined by a bottom 21a two side walls 21b and 21c, and the inner surfaces of two flanges 21d and 21e, as shown in FIG. 2. The flanges 21d and 21e have distal ends that define a slot 21f. In the example, referring to FIG. 1, the j-box guide tracks 20 are unitary portions of the exterior of the socket j-box body 18 and extend along the length of the socket j-box body 18. Each j-box guide track slot 21f has a distal end and a proximal end relative to the socket 1. The disclosed embodiments provide an advantage of easier manufacturing because only a single hole (e.g., adjustment bracket guide channel 12) need be provided in each adaptor plate adjustment bracket instead of multiple holes, much less multiple holes that each needs to be at a precise location.

The socket j-box body 18 has several built-in heat sink components 19 (e.g., heat sink fins). In the example, the entire socket j-box body 18 is an aluminum extrusion, including built-in heat sink fins 19 that are formed during manufacturing of the socket j-box body.

The adaptor plate adjustment brackets 9 may be secured to the j-box reflector adaptor plate 8 through a typical fastening technique such as welding or, in alternative embodiments, the j-box reflector adaptor plate 8 and adaptor plate adjustment brackets 9 may be formed as a single component or secured together by fasteners.

During assembly of the light reflector socket device 100, each of the adaptor plate adjustment brackets 9 may be placed alongside a corresponding j-box guide track 20 with the j-box reflector adaptor plate 8 located at the desired position along the length of the combined socket 1 and j-box 18. The adaptor plate adjustment brackets then may be secured to the socket j-box body 18 by one or more mounting assemblies.

A mounting assembly can include a washer, nut, and bolt combination. In the example, a guide track washer 16 is located facing the outer surface of each of the three adaptor plate adjustment brackets 9, and a j-box guide track nut 15 is located inwardly of each of the adaptor plate adjustment brackets 9. A guide track bolt 17 can be inserted through a guide track washer 16, an adjustment bracket slot 12, and the bore of a j-box guide track nut 15.

In the example, the guide track bolts 17 are ⅜-inch size 6 Phillips pan head screws having 32 threads per inch, the guide track washers 16 are 0.062 inches thick having an inner diameter of 3/16-inch and an outer diameter of ½-inch, and the j-box guide track nuts 15 are size 6 having 32 threads per inch and have a width of 5/16-inch and a thickness of ⅛-inch.

The sub-assembly that includes the j-box reflector adaptor plate 8, the adaptor plate adjustment brackets 9, the j-box guide track nuts 15, the guide track washers 16, and the guide track bolts 17, initially may be positioned at one of the ends of the socket j-box body 18 such that each of the guide track bolts 17 is aligned with a corresponding j-box guide track slot 21f. The socket j-box body 18 then may be moved parallel to the sub-assembly such that each of the guide track bolts 17 moves parallel to the socket j-box housing 18 inside the corresponding j-box guide track channel 21g. The guide track bolt 17 of each assembly can then be rotated until flanges 21d and 21e are clamplingly engaged between the adaptor plate adjustment bracket 9 and the j-box guide track nut 15, thereby fixing the desired position of the j-box reflector adaptor plate 8.

The telescoping effect provided by the disclosed technology is advantageous because it provides a significantly large number of possible positions that the socket j-box body 18 may have relative to the j-box reflector adaptor plate 8. Indeed, there is infinite position adjustability within the range provided by the length of the j-box guide tracks 20 and the length of the adjustment bracket slots 12. This arrangement provides the additional advantage of easy re-positioning of the j-box reflector adaptor plate 8 relative to the socket j-box body 18.

A j-box outer end plate 24 is located at the end of the socket j-box body 18 that is farthest from the socket 1. The j-box outer end plate 24 can be secured to the socket j-box body 18 by passing three end plate screws 27 through outer end plate screw holes 25 in the j-box outer end plate 24 and securing the end plate screws 27 in the socket j-box body 18. In the example, the end plate screws 27 are ½-inch size 8 Phillips sheet metal screws having 14 threads per inch.

In the example, the j-box inner end plate 7, j-box reflector adaptor plate 8, adaptor plate adjustment brackets 9, and j-box outer end plate 24 each have a thickness of 1.5 millimeters. In the example, the j-box inner end plate 7 and the j-box outer end plate 24 have noticeably different shapes.

In the example, two socket screws 3 may be passed through holes defined in the socket 1 as well as socket screw holes 6 and secured in channels provided in the socket j-box body 18. The socket j-box body 18 has a ground screw channel 22 into which a ground screw 29 may be secured. The ground screw 29 may be passed through a lock washer 32 and an uninsulated pressure terminal connector 31 before being secured in the ground screw channel 22. A ground wire (not shown) extends from the uninsulated pressure terminal connector 31 for grounding the assembly.

FIG. 2 shows a portion of the light reflector socket device 100 in greater detail. One of skill in the art can appreciate that the ground screw 29 can be passed through the lock washer 32 and the uninsulated pressure terminal connector 31 before being secured in the ground screw channel 22. FIG. 2 also shows the j-box guide track slots 21fwithin the j-box guide tracks 20 in greater detail.

FIG. 3 shows another portion of the light reflector socket device 100 in greater detail. The socket 1 has a threaded electrode 33 sized and shaped to mate with the threaded electrode of a light bulb received in the socket 1. In the example of FIG. 3, the j-box reflector adaptor plate 8 is positioned adjacent to the end of the socket opposite the end with the opening to the threaded electrode 33.

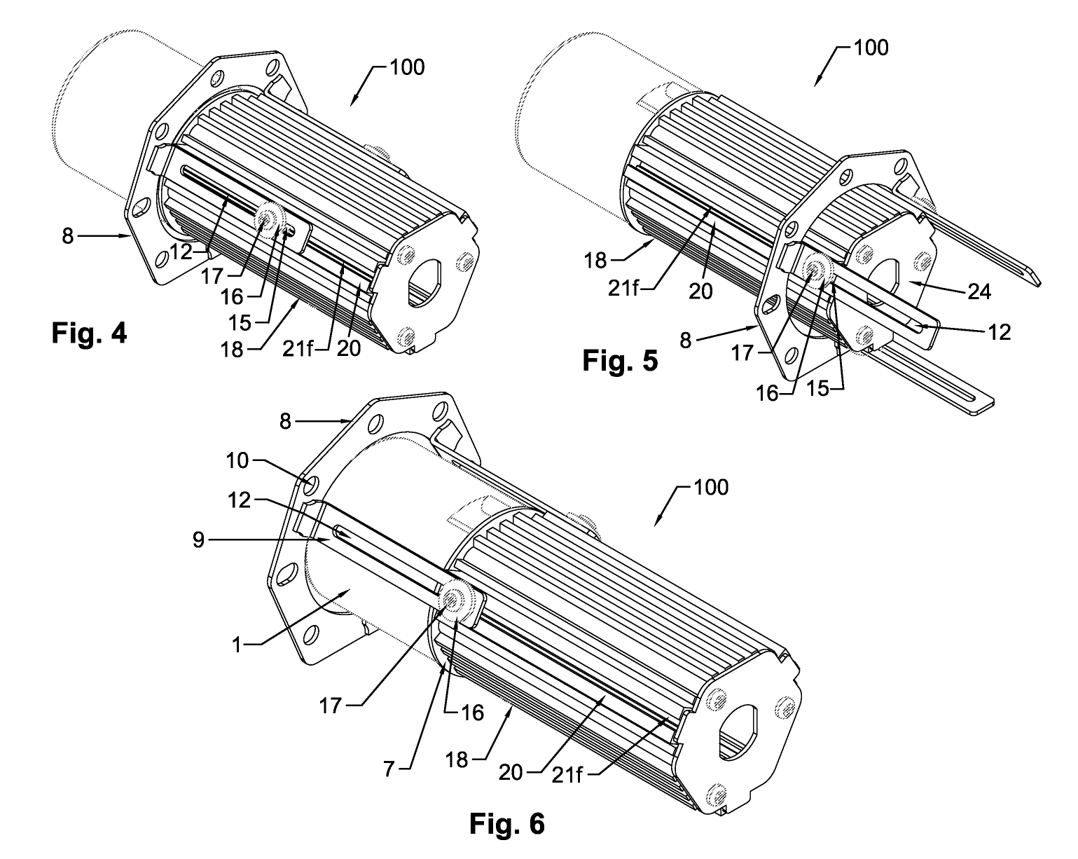

FIGS. 4-6 show the light reflector socket device 100 with the j-box reflector adaptor plate 8 at example axial positions with respect to the socket j-box body 18. One of skill in the art can appreciate that the j-box reflector adaptor plate 8 can be positioned in a variety of locations because, in the example, there are two main adjustment features that provide for positioning the j-box reflector plate 8. The first feature is the location of the guide track nuts 15 inside the j-box guide track channels within the j-box guide tracks 20. The guide track bolts 17 pass through the guide track washers 16 and engage the guide track nuts 15. In the example, the guide track nuts 15 can be placed at any spatial location along the length of the j-box guide track channels. The second feature is the location of the guide track bolts 17 along the length of the adjustment bracket slots 12. In the example, the placement of the adaptor plate adjustment brackets 9 is determined in part by the positioning of the guide track bolts 17, which can be located at any spatial location along the length of the adjustment bracket slots 12.

FIG. 4 shows the j-box reflector adaptor plate 8 positioned such that it is substantially aligned with the j-box inner end plate 7. In the example, the guide track nuts 15 are located approximately midway along the j-box guide track slots 21f and the corresponding guide track washers 16 and guide track bolts 17 are closer to the distal ends of the adjustment bracket slots 12 than to the proximal ends.

FIG. 5 shows the j-box reflector adaptor plate 8 positioned as close to the j-box end plate 24 as it can go in the example. The guide track nuts 15 are located at the proximal end of the j-box guide track slots 21f and the corresponding guide track washers 16 and guide track bolts 17 are at the proximal ends of the adjustment bracket slots 12.

FIG. 6 shows the j-box reflector adaptor plate 8 located as far from the j-box end plate 24 as it can go in the example. The guide track nuts 15 are located at the distal ends of the j-box guide track slots 21f and the corresponding guide track washers 16 and guide track bolts 17 are at the distal ends of the adjustment bracket slots 12.

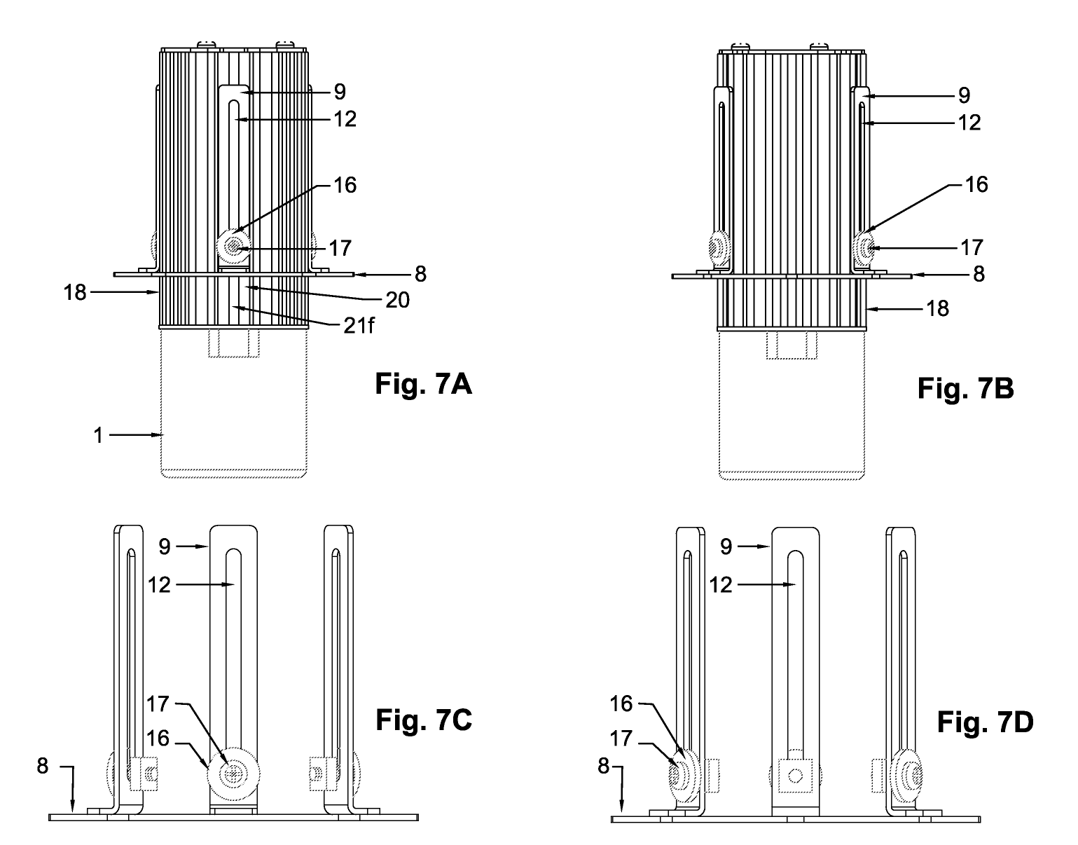

FIGS. 7A-D show an example orientation of the j-box reflector adaptor plate 8 with respect to the socket j-box body 18 using the adaptor plate adjustment brackets 9. FIG. 7A shows a side view of the entire assembly from a first side. FIG. 7B shows a side view of the entire assembly from the side opposite the first side shown in FIG. 7A. FIG. 7C shows a side view of the j-box reflector adaptor plate with the attached adaptor plate adjustment brackets and three sets of guide track bolt, guide track washer, and j-box guide track nut assemblies attached thereto. FIG. 7D shows a side view of the arrangement shown in FIG. 7C but from the side opposite the side shown in FIG. 7C.

In the example, the guide track washers 16 and the guide track bolts 17 are located at the proximal ends of the adjustment bracket slots 12 and roughly a quarter of the distance from the proximal end of the socket j-box body 18 to the distal end of the socket j-box body 18. The corresponding guide track nuts 15 are located at corresponding locations in the j-box guide track slots 21f within the j-box guide tracks 20. As a result, the j-box reflector adaptor plate 8 is slightly less than a quarter of the distance from the proximal end of the socket j-box body 18 to the distal end of the socket j-box body 18.

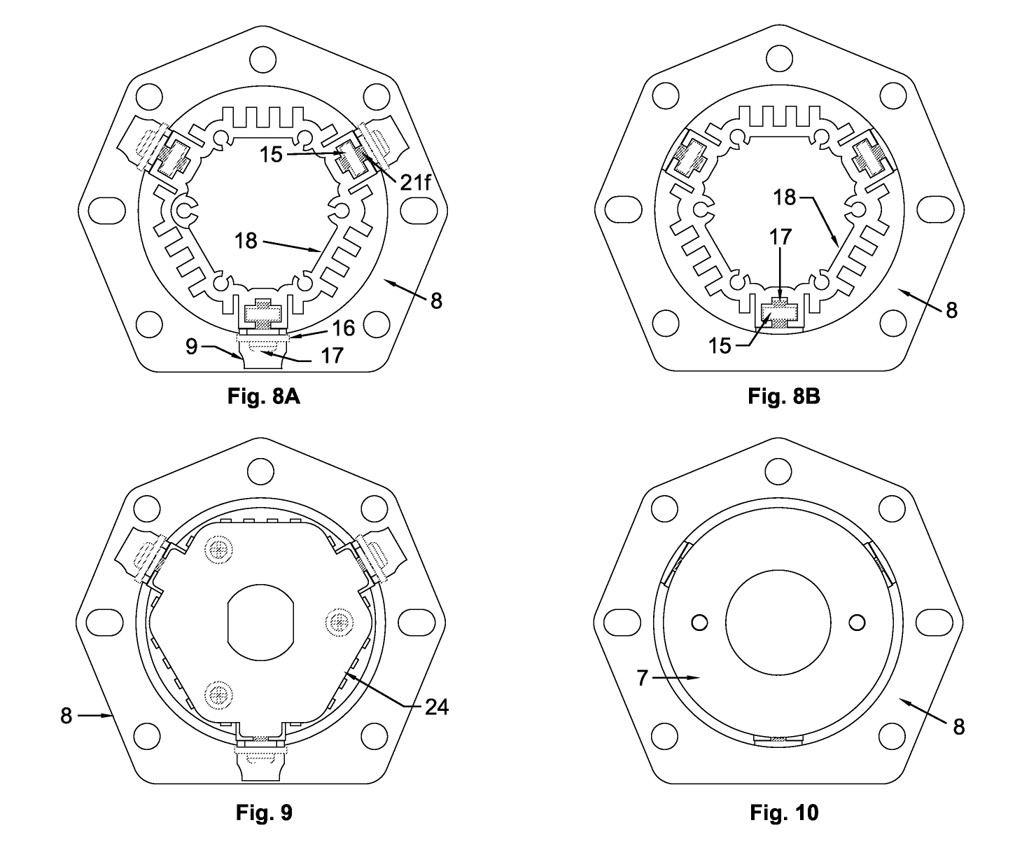

FIGS. 8A-B show vertical cross-sectional views of the light reflector socket device 100 having a j-box reflector adaptor plate 8 with three sets of j-box guide track nuts 15, guide track washers 16, and guide track bolts 17 used to secure the adaptor plate adjustment brackets 9 alongside the three j-box guide tracks 20, and thus secure the j-box reflector adaptor plate 8 to the socket j-box body 18. FIG. 8A shows a view from the side of the j-box reflector adaptor plate 8 to which the adaptor plate adjustment brackets 9 are attached. FIG. 8B shows a view from the opposite side of the j-box reflector adaptor plate 8.

FIG. 9 is a side view of the light reflector socket device 100 with the j-box outer end plate 24 attached to the socket j-box body 18.

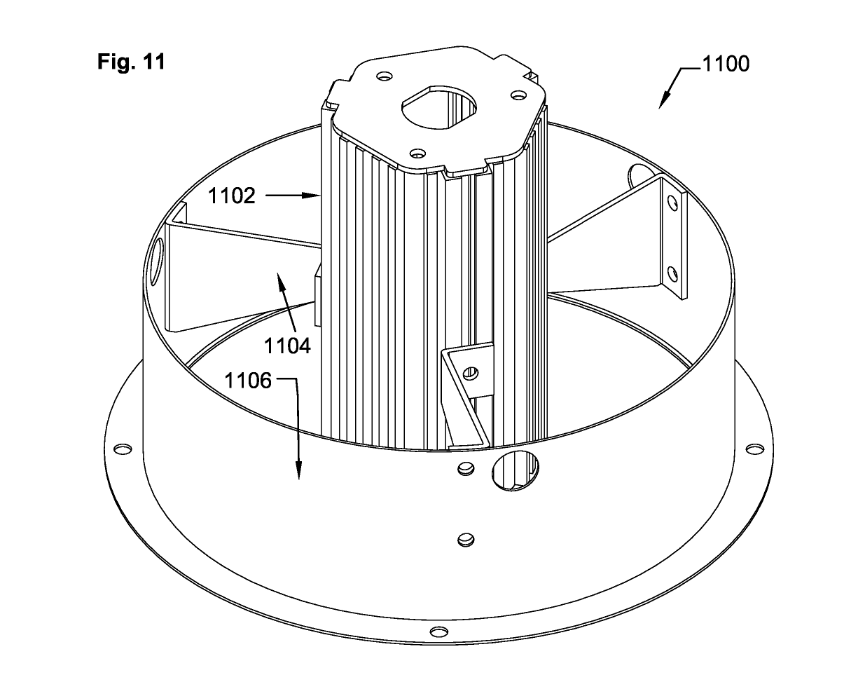

FIG. 10 is a vertical cross-sectional view of the light reflector socket device 100 with the j-box inner end plate 7 secured to the socket j-box body 18 by two socket screws 3.

FIG. 11 is an oblique view of an alternative embodiment of a light reflector socket assembly 1100 that includes a j-box body 1102, three reflector adaptor adjustment brackets 1104, and a reflector adaptor 1106. In the example, each of the reflector adaptor adjustment brackets 1104 has one end that can be mounted to the j-box body 1102 using, for example, a bolt, nut, and washer assembly (not shown). The other end can be mounted to the reflector adaptor 1106 using, for example, a bolt, nut, and washer assembly (not shown). The light reflector socket assembly 1100 provides additional advantages such as, for example, a greater airspace between the j-box body 1102 and the reflector adaptor 1106. This arrangement can provide a large air vent area and low air resistance.

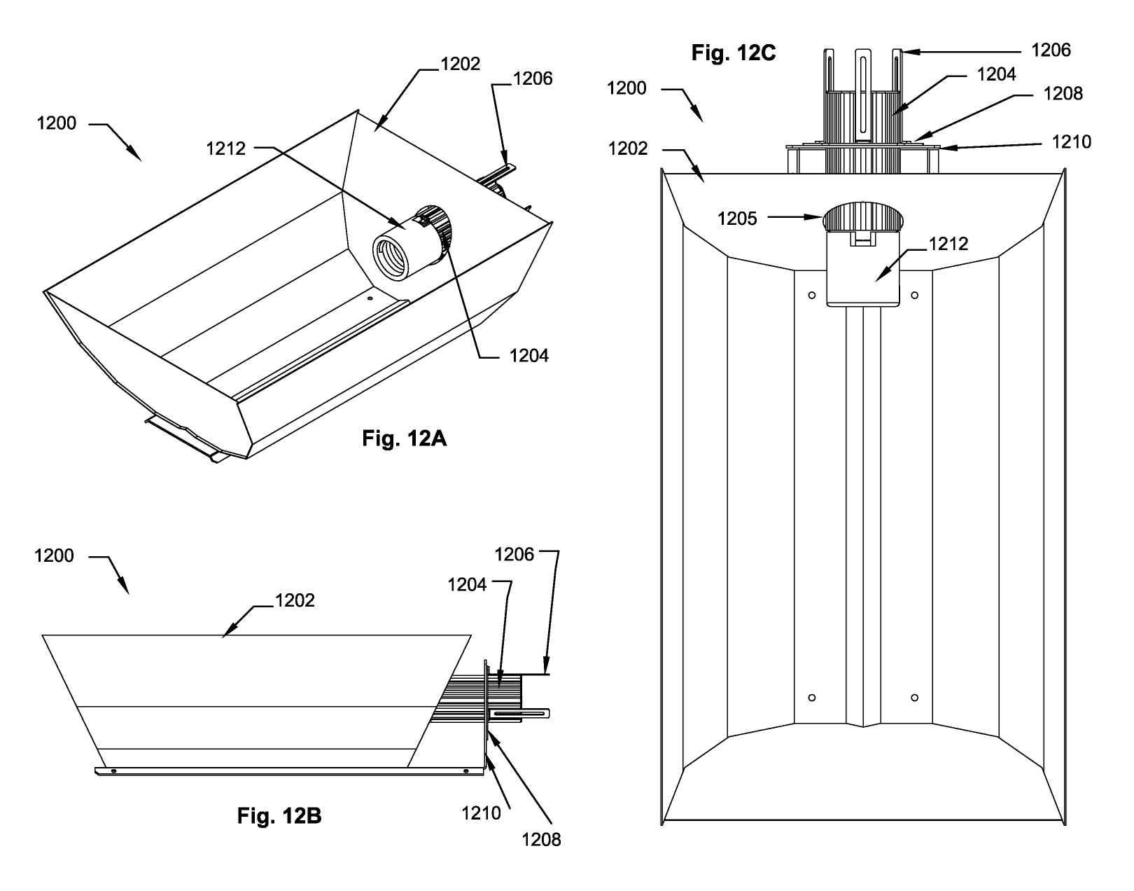

FIGS. 12A-C show a light reflector assembly 1200 that includes a light reflector 1202 on which is mounted a light reflector socket device 1204. The light reflector socket device 1204 extends through an opening 1205 defined by an end wall of the illustrated reflector 1202. In the example, the light reflector socket device 1204 includes a reflector adaptor plate 1208. The reflector adaptor plate 1208 mates with a receiving plate 1210 that may be a built-in part of, or a separate component attached to, the light reflector 1202. The light reflector socket device 1204 has a j-box 1210, a light socket 1212, and three adaptor plate adjustment brackets 1206 that extend from the reflector adaptor plate 1208. As described above, the j-box 1210 and adaptor plate adjustment brackets 1206 are constructed to allow the light reflector socket device 1204 to be placed in any one of a variety of positions within the light reflector 1202.

Although the present invention has been described in connection with specific illustrations, it will be understood that the invention is not limited to the views shown. On the contrary, the invention is intended to encompass all modifications, alternatives, and equivalents as may be included within the spirit and scope of the invention, as defined by the appended claims.

1. A light reflector socket device, comprising:
a socket;
a j-box body coupled to the socket, the j-box body comprising at least one j-box guide track defining a j-box guide track slot;
a reflector adaptor, the reflector adaptor comprising a reflector adaptor plate and at least one adaptor plate adjustment bracket adapted to be placed along the j-box guide track; and
at least one adaptor plate adjustment bracket mounting assembly adapted to couple the adaptor plate adjustment bracket to the j-box guide track, the mounting assembly being adjustable between a first position, wherein the adaptor plate adjustment bracket is able to slide alongside the j-box guide track, and a second position wherein the adaptor plate adjustment bracket is immovably secured to the adjacent j-box guide track.

2. The light reflector socket device of claim 1, wherein:
the j-box body comprises a plurality of j-box guide tracks, each of the plurality of j-box guide tracks defining a corresponding one of a plurality of j-box guide track slots;
the reflector adaptor comprises a plurality of adaptor plate adjustment brackets, wherein each of the plurality of adaptor plate adjustment brackets is adapted to be placed along a corresponding one of the plurality of j-box guide tracks; and
the light reflector socket device comprises a plurality of adaptor plate adjustment bracket mounting assemblies, each of the plurality of adaptor plate adjustment bracket mounting assemblies being adapted to couple a corresponding one of the plurality of adaptor plate adjustment brackets to the corresponding one of the plurality of j-box guide tracks, at least one of the mounting assemblies being adjustable between a first position, wherein each of the plurality of adaptor plate adjustment brackets is able to slide alongside the corresponding one of the plurality of j-box guide tracks and a second position wherein at least one of the adaptor plate adjustment brackets is immovably secured to the adjacent j-box guide track.

3. The light reflector socket device of claim 2, wherein each of the plurality of adaptor plate adjustment bracket mounting assemblies comprises a j-box guide track bolt and a mating j-box guide track nut, the j-box guide track nut being sized and shaped to be cagedly received within the corresponding one of the plurality of j-box guide tracks.

4. The light reflector socket device of claim 3, wherein the mating j-box guide track nut is located within a corresponding one of the plurality of j-box guide tracks, and wherein a corresponding j-box guide track bolt extends through a corresponding one of the plurality of adaptor plate adjustment brackets and into the mating j-box guide track nut.

5. The light reflector socket device of claim 4, wherein at least one of the guide track bolts and the corresponding guide track nut clampingly engage the corresponding one of the plurality of j-box guide tracks with the corresponding one of the plurality of adaptor plate adjustment brackets.

6. The light reflector socket device of claim 2, further comprising a socket insulator mounted between the socket and the socket j-box body.

7. The light reflector socket device of claim 2, further comprising a j-box inner end plate mounted between the socket and the socket j-box body.

8. The light reflector socket device of claim 2, further comprising a j-box outer end plate mounted at a distal end of the j-box body.

9. The light reflector socket device of claim 2, further comprising a light reflector adapted to be coupled with the reflector adaptor plate.

10. The light reflector socket device of claim 2, wherein the j-box body further comprises a plurality of heat sink components.

11. A system for reflecting light the system comprising:
a socket assembly comprising a light reflector adaptor, a light socket, and a junction box, wherein the light socket is coupled to the junction box, and wherein the light reflector adaptor is configured to be mounted to the junction box using a plurality of mounting assemblies such that the light reflector adaptor can be moved along the junction box when each of the plurality of mounting assemblies is in a first position and such that the light reflector adaptor cannot be moved along the junction box when at least one of the mounting assemblies is in a second position; and
a light reflector mounted to the light reflector adaptor.

12. A system, comprising:
a light reflector;
a junction box;
a socket coupled to the junction box; and
a reflector adaptor that secures the junction box to the reflector in a fixed position that is adapted to allow infinite adjustment of the fixed position of the junction box relative to the reflector along a range of motion.
